(19) United States
(12) Patent Application Publication
(10) Pub. No.: US 2012/0230657 A1
(43) Pub. Date: Sep. 13, 2012

(54) HEATING DEVICE

(75) Inventor: Keiichi Uno, Kariya-city (JP)

(73) Assignee: DENSO CORPORATION, Kariya-city (JP)

(21) Appl. No.: 13/412,953

(22) Filed: Mar. 6, 2012

(30) Foreign Application Priority Data
Mar. 8, 2011 (JP) 2011-050144

(51) Int. Cl. F28D 15/02; H05B 3/00

(52) U.S. Cl. 392/308; 165/104.21

(57) ABSTRACT

A heating device includes a loop heat pipe and a plurality of heat sources. The loop heat pipe has an evaporation part, and a heat transferred by the loop heat pipe is used for a heating. The plurality of heat sources that heats a liquid phase working fluid is arranged in the evaporation part of the loop heat pipe.

### CROSS REFERENCE TO RELATED APPLICATION

This application is based on Japanese Patent Application No. 2011-50144 filed on Mar. 8, 2011, the disclosure of which is incorporated herein by reference in its entirety.

### TECHNICAL FIELD

The present disclosure relates to a heating device.

### BACKGROUND

JP-A-2008-296646 describes an in-vehicle air-conditioner having a heating device that performs a heating using heat generated from a heat source. The heating device has a first system using heat exhausted from an engine as the heat source, and a second system using electricity supplied from a battery as the heat source. The first system and the second system are independent from each other, and are selectively used based on demand or energy efficiency of the heating.

The second system includes a heat pump or electric heater such as PTC heater in JP-A-2008-296646.

Because the plural heat sources are selectively used, the heating can be performed with better fuel efficiency (energy efficiency). However, because the heating device becomes large and complicated, the heating device becomes expensive and may have the redundant function.

### SUMMARY

It is an object of the present disclosure to provide a heating device that has a simple construction.

According to an example of the present disclosure, a heating device includes a loop heat pipe and a plurality of heat sources. The loop heat pipe has an evaporation part, and a heat transferred by the loop heat pipe is used for a heating. The plurality of heat sources heating a liquid phase working fluid is arranged in the evaporation part of the loop heat pipe.

Accordingly, the construction of the heating device can be made simple.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a heating device according to an embodiment;

FIG. 2 is a schematic view illustrating a loop heat pipe of the heating device;

FIG. 3 is an operation chart of the heating device relative to a variation in a heating load; and

FIG. 4 is an operation chart of the heating device relative to an engine operation.

### DETAILED DESCRIPTION

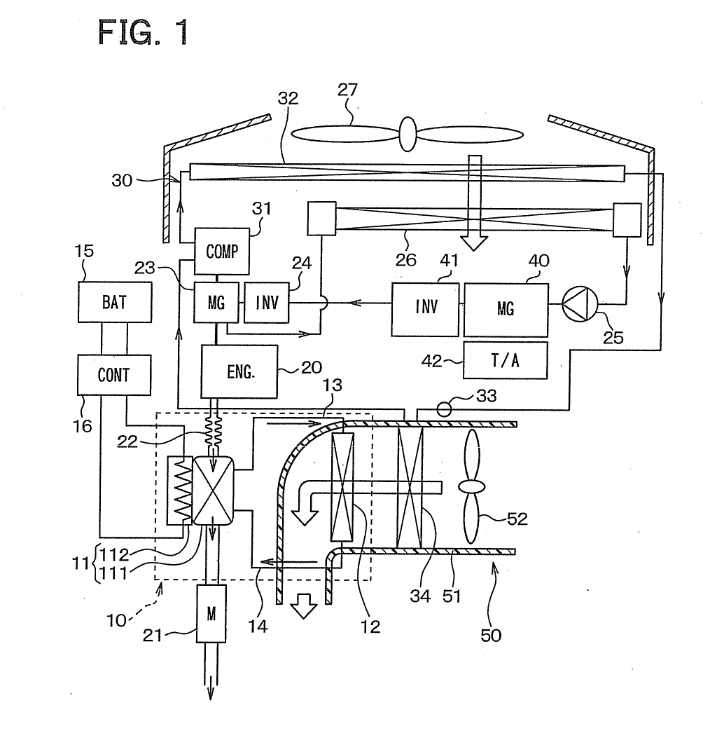

A heating device according to an embodiment is applied to an air-conditioner for a vehicle. FIG. 1 illustrates a series type hybrid vehicle having the air-conditioner.

The heating device has a loop type heat pipe 10 (heat loop). The heat pipe 10 performs heat transfer (heat transport) by evaporation and condensation of a working fluid. The heat transported by the heat pipe 10 is used for heating.

The heat pipe 10 has a tightly-closed container which is defined by annularly connecting an evaporation part 11, a condensation part 12, a vapor pipe 13 and a liquid refluxing pipe 14. The working fluid is enclosed inside of the container. For example, water is used as the working fluid.

In the evaporation part 11, the working fluid having liquid state is heated so as to be evaporated into a vapor (gas). The vapor generated by the evaporation in the evaporation part 11 moves to the condensation part 12 through a vapor passage defined in the vapor pipe 13. In the condensation part 12, the vapor is cooled and condensed into liquid state. The liquid fluid condensed in the condensation part 12 flows back to the evaporation part 11 through a liquid refluxing passage defined in the liquid refluxing pipe 14.

The vapor passage and the liquid refluxing passage are separated from each other in the heat pipe 10. Interference does not occur between the flow of vapor and the flow of liquid, so that the heat pipe 10 has a very high heat transport capability.

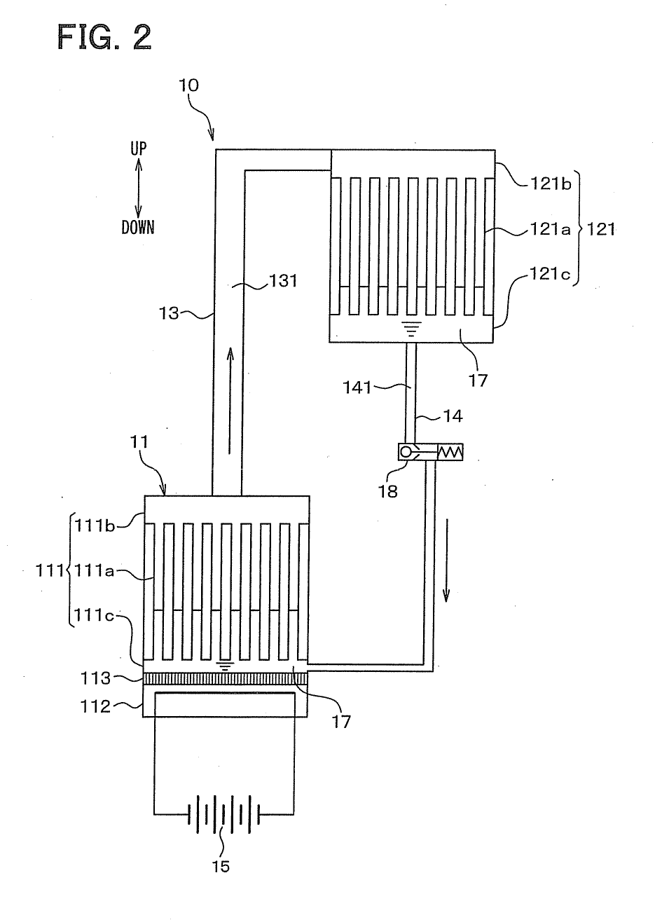

For example, the heat pipe 10 is a thermo siphon type pipe. That is, the liquid condensed in the condensation part 12 flows back to the evaporation part 11 due to gravity. As shown in FIG. 2, the evaporation part 11 is arranged below the condensation part 12 so as to enable the liquid flow back by gravity. The liquid flow back is not limited to be performed by gravity. Alternatively, the liquid flow back may be performed using a capillary phenomenon provided by a steel wool, for example.

The evaporation part 11 is constructed in a manner that the liquid phase working fluid is heated by plural heat sources in the evaporation part 11. In this embodiment, heat exhausted from an engine 20 of the vehicle and electricity may correspond to the plural heat sources.

More specifically, the evaporation part 11 has a heat-recovery heat exchanger 111 and an electric heater 112. In the heat exchanger 111, heat is exchanged between gas exhausted from the engine 20 and the liquid phase working fluid. The electric heater 112 heats the liquid phase working fluid existing in the heat exchanger 111.

The heat exchanger 111 is disposed in an exhaust passage of the engine 20. As shown in FIG. 1, the heat exchanger 111 is arranged between the engine 20 and a muffler 21. An exhaust pipe 22 extending from the engine 20 to the heat exchanger 111 may be a flexible tube having a bellows shape, so that vibration of the engine 20 is absorbed and is restricted from being transmitted to the heat exchanger 111.

The engine 20 drives a motor generator 23 and a compressor 31 of a refrigerating cycle 30. A clutch (not shown) intermittently transmits or stops the driving force from the engine 20 to the motor generator 23 and the compressor 31. When the transfer of the driving force from the engine 20 to the motor generator 23 and the compressor 31 is intercepted, the motor generator 23 can drive the compressor 31 as a motor. Moreover, it is also possible to use the motor generator 23 as an engine starter when the engine 20 is stopped.

The motor generator 23 and an inverter 24 for the motor generator are cooled by cooling water that circulates in a cooling water circuit. The cooling water circuit has a water pump 25, a radiator 26 and the like.

The water pump 25 circulates the cooling water in the cooling water circuit. The radiator 26 is a heat exchanger that emits heat of the motor generator 23 and the inverter 24 to outside. For example, outside air is sent to the radiator 26 by a cooling fan 27.

A drive motor 40 (motor generator) of the vehicle and an inverter 41 for the drive motor are also cooled by the cooling water which circulates through the cooling water circuit. An output shaft of the drive motor 40 is connected to a trans axle 42 of the vehicle. In addition, a part of the engine 20 may be cooled with the cooling water flowing through the cooling water circuit.

The electric heater 112 receives electricity supply from a battery 15 (storage battery) mounted to the vehicle. For example, a positive temperature coefficient (PTC) heater having PTC characteristics is used as the electric heater 112. A controller 16 controls a value of current flowing through the electric heater 112. The battery 15 may be a high voltage battery for driving or an auxiliary lead battery.

The compressor 31 draws and discharges refrigerant of the refrigerating cycle 30. The refrigerating cycle 30 has the compressor 31, a radiator 32, an expansion valve 33, and an evaporator 34.

The radiator 32 is a heat exchanger for emitting heat of high-temperature and high-pressure refrigerant discharged out of the compressor 31 to outside air outside of a passenger compartment of the vehicle. Outside air is sent to the radiator 32 by the cooling fan 27.

The expansion valve 33 is a decompressing portion that decompresses and expands refrigerant flowing out of the radiator 32.

The evaporator 34 is a heat exchanger for cooling air to be sent into the passenger compartment by evaporating the low-pressure refrigerant flowing out of the expansion valve 33, so as to achieve the heat absorbing effect. The refrigerant flowing out of the evaporator 34 is drawn by the compressor 31.

The evaporator 34 is arranged in a casing 51 of an indoor air-conditioning unit 50. An air passage is defined in the case 51. An air-conditioning fan 52 is arranged in the case 51 upstream of the evaporator 34 in the air flowing direction. The fan 52 sends air to the evaporator 34.

A switch box (not shown) is arranged at the most upstream of the case 51 in the air flowing direction so as to selectively introduce inside air and outside air. An air outlet is defined at the most downstream of the case 51 in the air flowing direction, and blows out the air conditioned in the air passage of the case 51 into the passenger compartment. An air-conditioning duct (not shown) is connected to the air outlet.

The condensation part 12 of the heat pipe 10 is arranged in the case 51, on the downstream side of the evaporator 34 in the air flowing direction. The condensation part 12 is a heat exchanger for heating the air sent from the fan 52 by exchanging heat with gas phase working fluid flowing in the heat pipe 10.

The inside air or outside air is introduced in the case 51 by the fan 52, and is sent to the evaporator 34 and the condensation part 12. The air passing through the evaporator 34 and the condensation part 12 is blown into the passenger compartment through the air outlet of the case 51 and the duct connected to the case 51. The air is dehumidified by the evaporator 34, and is reheated by the condensation part 12 so as to control the temperature of the air. The conditioned-air is sent to the passenger compartment.

FIG. 2 illustrates the heat pipe 10. Up and down directions of FIG. 2 represent up and down directions, respectively, in the vehicle.

The heat exchanger 111 of the evaporation part 11 has plural tubes 111a, an upper tank 111b and a lower tank 111c. The tube 111m defines a passage for the working fluid, and the tank 111b, 111c distributes or gathers the working fluid relative to the tubes 111a. A gas passage is defined between the tubes 111a, and exhaust gas of the engine 20 flows through the gas passage. The tubes 111a are arranged to extend in the up-and-down direction in the vehicle.

The electric heater 112 of the evaporation part 11 is integrated with the heat exchanger 111. For example, the electric heater 112 is tightly fixed to the heat exchanger 111 through a carbon sheet 113.

The carbon sheet 113 buries a clearance between the electric heater 112 and the heat exchanger 111, and secures a predetermined heat transfer area from the electric heater 112 to the heat exchanger 111. A thickness of the carbon sheet 113 is as thin as possible. In other words, the electric heater 112 is connected to the heat exchanger 111 in a manner that a thermal resistance becomes as small as possible relative the liquid phase working fluid in the heat exchanger 111. Instead of the carbon sheet 113, an adhesive or a grease having high heat conductivity may be used.

The electric heater 112 is attached to the lower part of the heat exchanger 111 in this example. More specifically, the electric heater 112 is attached to the lower tank 111c located on the lower side of the tubes 111a. For example, the electric heater 112 may be fixed to the tubes 111a.

The condensation part 12 has plural tubes 121a, an upper tank 121b and a lower tank 121c. The tube 121a defines a passage for the working fluid, and the tank 121b, 121c distributes or gathers the working fluid relative to the tubes 121a. An air passage is defined between the tubes 121a and air flows through the air passage. The tubes 121a are arranged to extend in the up-and-down direction in the vehicle.

The vapor pipe 13 connects the upper tank 111b of the heat exchanger 111 to the upper tank 121b of the condensation part 12. The gas phase working fluid which is gathered in the upper tank 111b of the heat exchanger 111 flows into the upper tank 121b of the condensation part 12 through the vapor passage 131 defined in the vapor pipe 13.

The liquid refluxing pipe 14 connects the lower tank 121c of the condensation part 12 to the lower tank 111c of the heat exchanger 111. The liquid phase working fluid which is gathered in the lower tank 121c of the condensation part 12 flows back to the lower tank 111c of the heat exchanger 111 through the liquid refluxing passage 141 defined in the liquid refluxing pipe 14.

An internal pressure regulating valve 18 is arranged in the middle of the liquid refluxing pipe 14, and opens/closes the liquid refluxing passage 141. The internal pressure regulating valve 18 is a mechanical valve which is biased by an elastic component such as a spring. If an internal pressure is raised in the valve 18, the valve body is displaced in a direction closing the liquid refluxing passage 141.

An operation of the heat pipe 10 will be described hereinafter. If the engine 20 is activated, the temperature (emission temperature) of the exhaust gas is raised, and the liquid phase working fluid 17 in the heat exchanger 111 boils and is changed into vapor phase. The vapor phase working fluid flows from the heat exchanger 111 through the vapor passage 131 in the vapor pipe 13, and is condensed in the condensation part 12 into the liquid phase working fluid 17. The liquid phase working fluid 17 flows from the condensation part 12 through the liquid refluxing passage 141 in the liquid refluxing pipe 14, due to gravity, and flows back into the evaporation part 11.

At this time, in the condensation part 12, the air sent by the fan 52 is heated, and the heated air is sent into the passenger compartment.

Further, also when the electric heater 112 is supplied with electricity, the temperature (heater temperature) of the electric heater 112 is raised, and the liquid phase working fluid 17 in the heat exchanger 111 boils and is changed into vapor phase. The air sent by the fan 52 is heated in the condensation part 12, and the heated air is sent into the passenger compartment.

A vapor pressure also rises when the emission temperature of the exhaust gas rises. When the vapor pressure rises, the internal pressure regulating valve 18 operates mechanically in the direction of closing the liquid refluxing passage 141. Therefore, the vapor pressure is restricted from excessively rising. That is, the internal pressure of the heat pipe 10 is adjusted by itself autonomously and spontaneously.

The PTC heater is used as the electric heater 112 in the embodiment. If the temperature of the electric heater 112 rises, the electric resistance value of the electric heater 112 is increased, and the output of the electric heater 112 is decreased. That is, the output of the electric heater 112 is adjusted by itself autonomously and spontaneously.

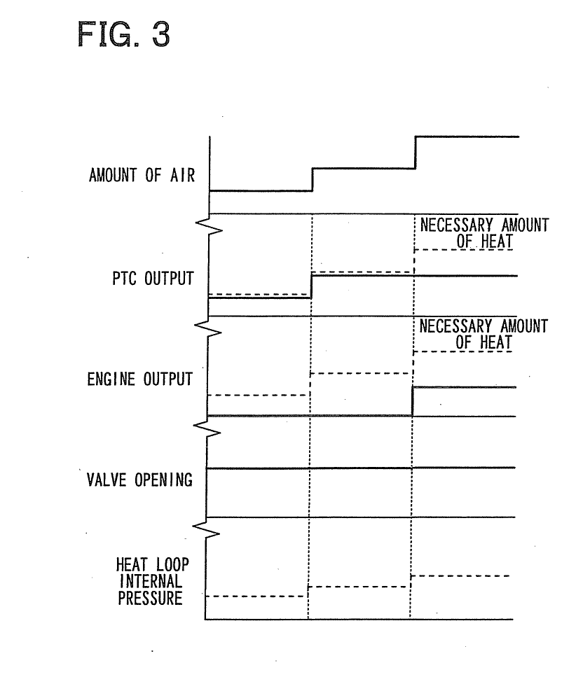

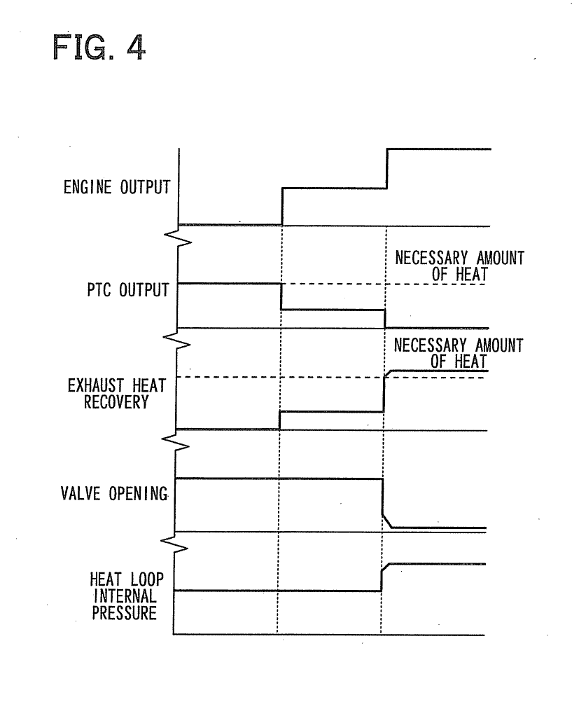

An example of the operation of the heating device is described with reference to FIGS. 3 and 4. FIG. 3 is an operation chart relative to a variation in a heating load. The blower air amount of FIG. 3 represents the heating load. That is, the fan 52 is controlled in a manner that the amount of air sent by the fan 52 is increased when the heating load becomes high and in a manner that the amount of air sent by the fan 52 is decreased when the heating load becomes low. The internal pressure of the heat loop 10 is increased in accordance with the increase in the amount of air sent by the fan 52 and in accordance with the increase in the heat output of the electric heater 112.

In a middle range of an abscissa of FIG. 3 where the heating load is middle, all the necessary amount of heat can be obtained by the PTC output of the electric heater 112, when the necessary amount of heat is in a middle range. At this time, it is not necessary to operate the engine 20 for the heating, and the valve 18 is totally opened.

In a left range of the abscissa of FIG. 3 where the heating load is low, the necessary amount of heat is small, and the blower air amount is decreased. Therefore, an amount of heat taken by the air is decreased, and the temperature of the electric heater 112 becomes high. Thus, the PTC output of the electric heater 112 is decreased due to the PTC characteristics of the electric heater 112, and the power consumption of the electric heater 112 can be restricted from increasing more than needed.

In a right range of the abscissa of FIG. 3 where the heating load is high, the necessary amount of heat is large, it becomes impossible to obtain all the necessary amount of heat from the electric heater 112. Therefore, the engine 20 is activated so as to increase the output, thereby obtaining a part of the necessary amount of heat that cannot be obtained by only the PTC output of the electric heater 112, from the exhaust gas of the engine 20. At this time, because the recovery amount of the exhausted heat is smaller than the necessary amount of heat, the open state of the valve 18 is maintained, and the internal pressure of the heat loop 10 is increased.

FIG. 4 is an operation chart relative to an operation of the engine 20. The engine 20 is controlled in a manner that the output of the engine 20 is increased when an amount of electricity required for the motor generator 23 is large and in a manner that the output of the engine 20 is decreased when the amount of electricity required for the motor generator 23 is small. FIG. 4 illustrates an example where the necessary amount of heat is in the middle range due to the middle heating load.

When the engine 20 is not active and has no output, as shown in left region of an abscissa of FIG. 4, heat of the gas exhausted from the engine 20 is not transmitted to the heater 112. Therefore, the temperature of the heater 112 does not excessively become high, and the PTC output of the heater 112 becomes large comparatively. Thus, all the necessary amount of heat can be obtained with the PTC output of the electric heater 112.

When the engine 20 operates and when the output of the engine 20 is in a middle range, as shown in middle range of the abscissa of FIG. 4, the temperature of the heat exchanger 111 is raised by the exhaust gas of the engine 20. Therefore, the temperature of the electric heater 112 becomes high, and the PTC output of the electric heater 112 is decreased.

In contrast, the heat pipe 10 recovers the heat of gas exhausted from the engine 20, so that the necessary amount of heat can be obtained with the PTC output of the electric heater 112 and the exhaust gas of the engine 20.

When the output of the engine 20 is in a high range, as shown in right range of the abscissa of FIG. 4, the exhaust gas of the engine 20 has high temperature, and the temperature of the heat exchanger 111 is further raised. Therefore, the temperature of the electric heater 112 becomes much higher, and the PTC output of the electric heater 112 is further lowered. However, the amount of heat recovered by the heat pipe 10 is increased, so that all the necessary amount of heat can be obtained by the exhaust gas of the engine 20.

Even if the temperature of the exhaust gas of the engine 20 became too much high, and if the amount of heat of the exhaust gas recovered by the heat pipe 10 exceeds the necessary amount of heat, the internal pressure regulating valve 18 operates in the direction closing the liquid refluxing passage 141, because the internal pressure of heat pipe 10 is increased. Therefore, the amount of heat of the exhaust gas recovered by the heat pipe 10 is restricted from becoming excessive.

According to the embodiment, the evaporation part 11 of the heat pipe 10 is heated by the plural heat sources such as the exhaust heat of the engine 20 and the electricity. Compared with the conventional art in which the plural heating systems are provided for the plural heat sources, respectively, the construction of the heating device of the present embodiment can be made simple without redundancy in the heat transport portion.

Because the heat pipe 10 is a thermo siphon type one, the liquid phase working fluid 17 condensed in the condensation part 12 flows back to the evaporation part 11 by gravity. Therefore, a liquid refluxing member such as pump or wick is unnecessary, and the construction of the heating device can be made simple.

According to the embodiment, the heat of the exhaust gas of the engine 20 is collected. Therefore, after the activation of the engine 20, the temperature of the exhaust gas is quickly raised, and the recovery of heat is quickly started. Moreover, according to the embodiment, the heating can be started only if a part of the liquid phase working fluid 17 boils.

In a conventional heating device, heat of cooling water is collected after the engine and the cooling water are warmed. Compared with the conventional heating device, the heating device of the present embodiment is better in thermal efficiency, and the heat capacity can be made smaller. Therefore, the heating can be started in a short time, and the fuel consumption can also be reduced. Moreover, a water pump for circulating the cooling water to the condensation part 12 is unnecessary, so that the power consumption can be reduced.

According to the embodiment, the internal pressure regulating valve 18 opens/closes the liquid refluxing passage 141 of the heat pipe 10 mechanically based on the internal pressure, and the electric heater 112 constructed by the PTC heater self-controls the output based on the own temperature. Therefore, the heating capacity is spontaneously controlled based on the operation state of the engine 20 and the variation in the heating load. Thus, the construction of the control system can be simplified, compared with a case where a heating capacity is electrically controlled using a control device.

Because the electric heater 112 is attached to the lower part of the heat exchanger 111, the electric heater 112 can be integrated with the heat exchanger 111 with the simple construction.

The heating device is applied to the series type hybrid vehicle in the above embodiment. Alternatively, the present disclosure may be applied to other vehicle having an engine and a battery. Moreover, the heating device of the present disclosure may be applied to a fixed type heating device which is used for a residence, for example.

In the above embodiment, the heat pipe 10 is the thermo siphon type one. Alternatively, the liquid phase working fluid 17 condensed in the condensation part 12 may flow back to the evaporation part 11 using a capillary force of a wick or a pump, for example.

The heat source is not limited to the exhaust heat of the engine 20 and the electricity. A variety of heat sources may be used instead of the exhaust heat of the engine 20 and the electricity.

The internal pressure regulating valve 18 may be omitted, and the electric heater 112 is not limited to the PTC heater. In this case, the heating capacity may be controlled electrically using an electric valve, an electric heater not having the PTC characteristics, and a control device which controls the electric valve and the electric heater.

Such changes and modifications are to be understood as being within the scope of the present disclosure as defined by the appended claims.

What is claimed is:

1. A heating device comprising:
a loop heat pipe having an evaporation part, a heat transferred by the loop heat pipe being used for a heating; and
a plurality of heat sources that heats a liquid phase working fluid, wherein the plurality of heat sources is arranged in the evaporation part of the loop heat pipe.

2. The heating device according to claim 1, wherein
the plurality of heat sources corresponds to a heat exhausted from an engine and an electricity.

3. The heating device according to claim 2, wherein
the evaporation part includes
a heat exchanger in which heat is exchanged between gas exhausted from the engine and the liquid phase working fluid, and
an electric heater that heats the liquid phase working fluid existing in the heat exchanger.

4. The heating device according to claim 3, further comprising:
a valve that opens/closes a liquid reflux passage of the loop heat pipe, wherein
the valve mechanically operates to close the liquid reflux passage when an internal pressure of the loop heat pipe becomes higher than a predetermined value, and
the electric heater is a PTC heater having PTC characteristics.

5. The heating device according to claim 3, wherein
the electric heater is attached to a lower side of the heat exchanger.

6. The heating device according to claim 3, wherein
the heat exchanger is arranged in an exhaust passage of the engine which is mounted to a vehicle, and
the electric heater receives electricity from a battery mounted to the vehicle.
